(19) United States
(12) Patent Application Publication
(10) Pub. No.: US 2009/0255159 A1
(43) Pub. Date: Oct. 15, 2009

(54) KIT FOR SIGNAGE SUSPENSION

(76) Inventor: Kevin Smith, Crown Point, IN (US)

Correspondence Address: MACMILLAN SOBANSKI & TODD, LLC, ONE MARITIME PLAZA FIFTH FLOOR, 720 WATER STREET, TOLEDO, OH, 43604-1619, US

(21) Appl. No.: 12/331,507

(22) Filed: Dec. 10, 2008

Related U.S. Application Data
(63) Continuation-in-part of application No. 12/101,535, filed on Apr. 11, 2008, now Pat. No. 7,513,073.

(51) Int. Cl. G09F 15/00

(52) U.S. Cl. 40/607.06

(57) ABSTRACT

A kit for suspending a sign is disclosed herein. The kit includes first and second column anchors operable to be mounted in the ground. Each column anchor has a plurality of fins facing in different directions from one another and a conical tip. The kit also includes first and second columns individually receivable in one of the first and second column anchors and selectively removable. Each of the columns has a plurality of through-apertures. The kit also includes a plurality of sets of eye-bolts and nuts, each individually receivable in one of the plurality of through-apertures. The kit also includes a plurality of cable members having latches or S-hooks at both ends and a stretchable member extending between the latches or S-hooks.

### CROSS-REFERENCE TO RELATED APPLICATIONS

This application is a continuation-in-part of U.S. patent application Ser. No. 12/101,535 for a KIT FOR SIGNAGE SUSPENSION filed on Apr. 11, 2008, which is hereby incorporated by reference in its entirety.

### BACKGROUND OF THE INVENTION

1. Field of the Invention

The invention relates to a kit for suspending a sign or banner.

2. Description of Related Prior Art

Signs and banners can be used by businesses, schools, individuals, and groups of all kinds to convey information. Signs are often positioned in elevated relation relative to the intended observers of the sign. Signs can also be suspended outside and vulnerable to wind. In order to best convey information, a sign should be taut when suspended.

### SUMMARY OF THE INVENTION

The invention is a kit for suspending a sign. The kit includes first and second column anchors operable to be mounted in the ground. Each column anchor has a plurality of fins facing in different directions from one another and a conical tip. The kit also includes first and second columns individually receivable in one of the first and second column anchors and selectively removable. Each of the columns has a plurality of through-apertures. The kit also includes a plurality of sets of eye-bolts and nuts, each individually receivable in one of the plurality of through-apertures. The kit also includes a plurality of cable members having latches or S-hooks at both ends and a stretchable member extending between the latches or S-hooks.

### BRIEF DESCRIPTION OF THE DRAWINGS

Advantages of the present invention will be readily appreciated as the same becomes better understood by reference to the following detailed description when considered in connection with the accompanying drawings wherein:

FIG. 1 is an exploded view of a first portion of a kit according to the exemplary embodiment of the invention;

FIG. 2 is an exploded view of a second portion of a kit according to the exemplary embodiment of the invention; and

FIG. 3 is front view of an alternative cable member for practicing the invention.

### DETAILED DESCRIPTION OF THE EXEMPLARY EMBODIMENT

The present application sets forth improvements made to the invention disclosed in U.S. patent application Ser. No. 12/101,535 for a KIT FOR SIGNAGE SUSPENSION filed on Apr. 11, 2008. The '535 application is hereby incorporated by reference in its entirety. Similar features are shown in the '535 application and the present application. Similar features have been numbered with a common reference numeral and have been differentiated by an alphabetic suffix. Also, to enhance consistency, the structures in any particular drawing share the same alphabetic suffix even if a particular feature is not shown in both applications. Similar features are structured similarly, operate similarly, and/or have the same function unless otherwise indicated by the drawings or this specification. Furthermore, particular features shown in the present application or the '535 application can replace corresponding features in the other application or can supplement arrangements in the other application unless otherwise indicated by the drawings or this specification in order to define alternative embodiments for practicing the present invention.

While those in the field of signage suspension have been satisfied by existing suspension systems, I have perceived the state of the art lacking. In an exemplary embodiment of my invention, a kit 10a can suspend a sign tautly and can do so repeatedly. My kit 10a is easy to use and yet provides consistently good results. The description below is directed to one side of a signage suspension kit; it is noted that the other side of the signage suspension kit can be structured similarly and operate similarly.

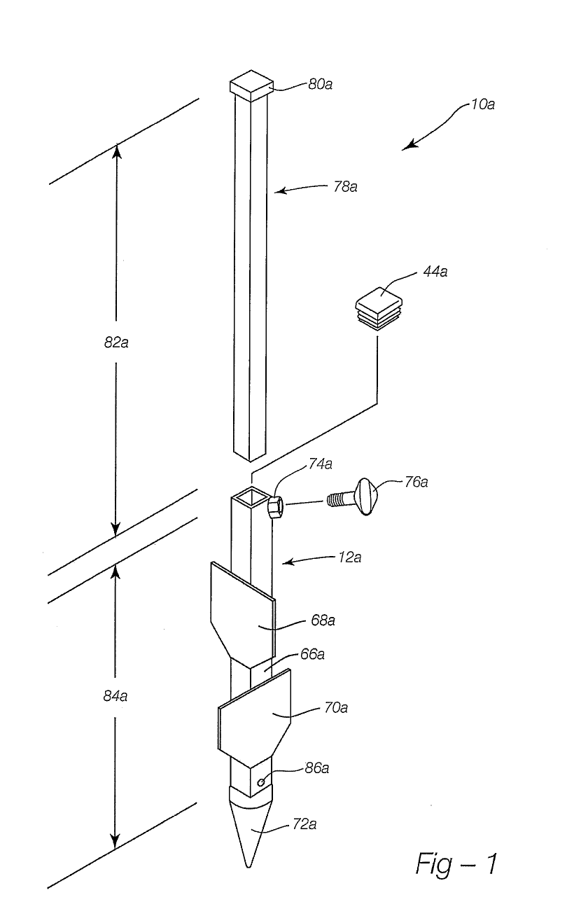

FIG. 1 shows a portion of a kit 10a according to the exemplary embodiment of my invention. The kit 10a can include first and second column anchors, such as column anchor 12a, operable to be permanently mounted in the ground or concrete. The column anchor 12a can include a hollow column sleeve portion 66a as well as first and second fins 68a, 70a fixed to the column sleeve portion 66a. The fins 68a, 70a can be facing different directions, such as perpendicular directions. In operation, the fins 68a, 70a can stabilize the column sleeve portion 66a. A conical tip 72a can be fixed to an end of the column sleeve portion 66a to ease insertion of the column sleeve portion 66a into the ground if the column sleeve portion 66a is not mounted in concrete.

The column anchor 12a can also include a boss 74a defining a threaded aperture. The threaded aperture can extend fully through to an interior of the column sleeve portion 66a. The threaded aperture can receive a thumb screw 76a, to be discussed in greater detail below.

The kit 10a can also include a driving member 78a. The driving member 78a can be received in the column anchor 12a and define a cap 80a. During installation into the ground, a hammer can be used against the cap 80a to drive the column anchor 12a downward, rather than being applied directly to the column anchor 12a. This exemplary process thereby reduces the likelihood mushrooming of the column anchor 12a. A length 82a of the driving member 78a can be greater than a length 84a of the column anchor 12a to further reduce the likelihood of mushrooming of the column anchor 12a. When the kit 10a is not in use, a cap 44a can be inserted in the column sleeve portion 66a to keep debris from the interior of the column sleeve portion 66a. Also, a drain aperture 86a can be defined in the column sleeve portion 66a to permit water to escape the interior of the column sleeve portion 66a.

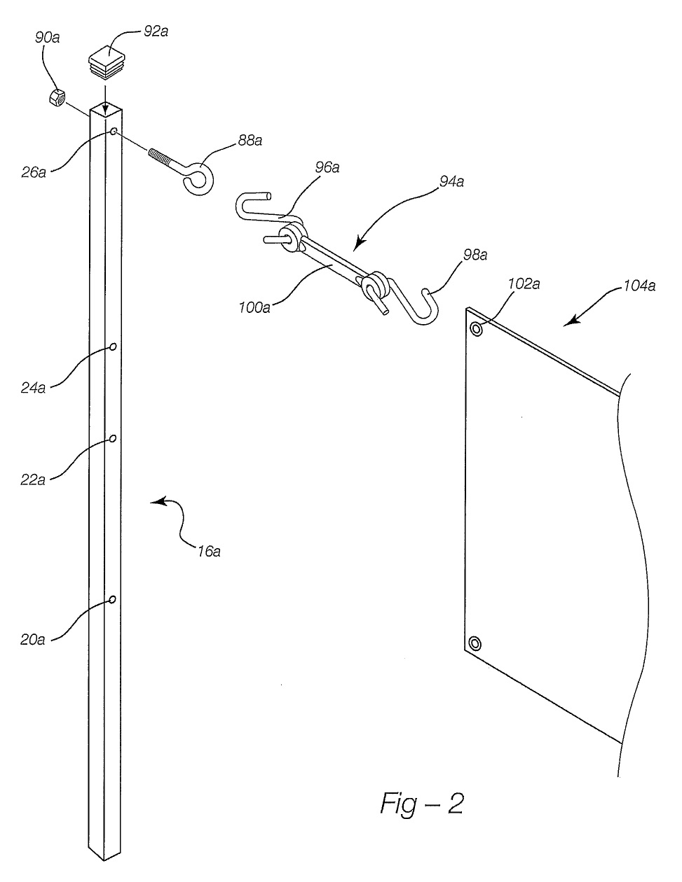

Referring now to FIG. 2, the kit 10a can also include first and second columns, such as column 16a, receivable in the column anchors 12a. The column 16a can be made from steel, aluminum or any other materials. Generally, all the components of the kit 10a can be made from weather-resistant materials if desired. The column 16a is selectively removable from the column anchor 12a when the kit 10a is not in use. The column 16a can have a plurality of through-apertures such as through-apertures 20a, 22a, 24a, 26a. The through-apertures 20a, 22a, 24a, 26a can be spaced from one another the same distance or different distances. Spacing the through-apertures 20a, 22a, 24a, 26a different distances from one another could make the kit 10a operable to suspend signs of different heights.

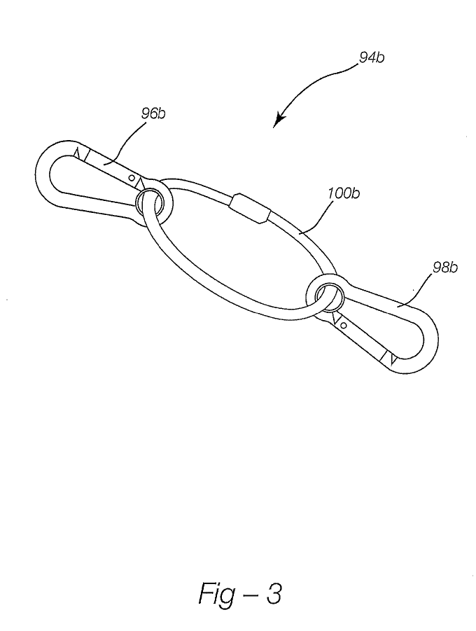

The kit 10a can also include sets of eye-bolts 88a and nuts 90a, such as four sets, one for each corner of the sign. The kit 10a can also include a cap 92a for the top of the column 16a, to enhance the aesthetic appearance of the kit 10a when suspending a sign. The kit 10a can also include cable members 94a, such as four cable members, one for each corner of the sign. The cable member 94a can include latches 96a, 98a at both ends, with a stretchable member 100a (such as rubber or elastomeric material) extending between the S-hooks 96a, 98a. The S-hook 96a can engage the eye-bolt 88a and the S-hook 98a can engage an eyelet 102a on the sign 104a. The use of the cable members 94a in the kit 10a can reduce the likelihood and/or severity of creep or plastic deformation of the column 16a. FIG. 3 shows an alternative cable member 94b having a stretchable member 100b formed as an endless bungee cord and two latches 96b, 98b. Each latch 96b, 98b can include a locking tab that is biased into a closed position (shown in FIG. 3), but can be urged inward to open the latch 96b, 98b for receiving the eye-bolt 88a or the eyelet 102a.

During assembly of one side of the signage support, the conical tip 72a of the column anchor 12a can be placed on the ground and the driving member 78a can be inserted in the column sleeve portion 66a. A hammer or other object can be struck against the cap 80a as often as necessary to drive the column anchor 12a substantially fully into the ground. It is desirable to leave the boss 74a exposed above ground level.

The column 16a can then be placed in the column sleeve portion 66a. The extent that the column 16a projects into the column sleeve portion 66a can be controlled by rotating the thumbscrew 76a inward to press against and hold the column 16a when the column 16a is in the desired position. This can be desirable when the sign is being suspended on uneven ground and the columns must be positioned differently. The boss 74a can be oriented at a non-perpendicular angle relative to the column sleeve portion 66a so that the thumbscrew 76a can be rotated without interference from the ground.

After the columns are positioned, eye-bolts 88a and nuts 90a are assembled in the desired apertures 20a, 22a, 24a, 26a. Next, latches 96a of cable members 94a are connected to the eye-bolts 88a and latches 98a are connected to eyelets 102a. Caps 92a can inserted in the top ends of the columns.

After the suspension of the sign is no longer desired, the cable members 94a can be disconnected from the sign 104a and the eye-bolts 88a and nuts 92. The eye-bolts 88a and nuts 92 can be disconnected from the column 16a. The thumbscrew 76a can be unscrewed and the column 16a can be removed from the column anchor 12a. The cap 44a can be inserted into the column sleeve portion 66a and disassembly can be complete.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A kit for suspending a sign comprising:
first and second column anchors operable to be mounted in the ground, each column anchor having a plurality of fins facing in different directions from one another and a conical tip;
first and second columns individually receivable in one of the said first and second column anchors and selectively removable and each having a plurality of through-apertures;
a plurality of sets of eye-bolts and nuts each individually receivable in one of said plurality of through-apertures; and
a plurality of cable members having one of latches and S-hooks at both ends and also having a stretchable member extending between said one of latches and S-hooks.

2. The kit of claim 1 further comprising:
at least one driving member receivable in both of the respective said first and second column anchors prior to said first and second columns being received in said first and second column anchors to drive said first and second column anchors into the ground.

3. The kit of claim 2 wherein:
each of said first and second column anchors include a boss defining a threaded through-aperture; and
said kit further comprises first and second thumbscrews individually receivable in one of said bosses to capture one of said first and second columns at a desired position.

4. The kit of claim 3 wherein said bosses are oriented at a non-perpendicular angle relative to said respective first and second column anchors such that said thumbscrews can be rotated without interference from the ground.

5. The kit of claim 4 further comprising:
first and second caps individually receivable in one of said first and second column anchors and selectively removable, the first and second column anchors receiving the first and second caps when the first and second columns have been removed.

6. The kit of claim 5 further comprising:
first and second caps individually receivable in a top end of one of said first and second columns and selectively removable.
